(19) United States
(12) Patent Application Publication
(10) Pub. No.: US 2008/0307002 A1
(43) Pub. Date: Dec. 11, 2008

(54) METHOD FOR PROVIDING AUDIO AND/OR VIDEO FILES

(76) Inventors: Dagmar STAROVESKA, Munchen (DE); Premysl STAROVESKA, Munchen (DE)

Correspondence Address: OSTROLENK FABER GERB & SOFFEN, 1180 AVENUE OF THE AMERICAS, NEW YORK, NY, 100368403, US

(21) Appl. No.: 12/123,857

(22) Filed: May 20, 2008

(30) Foreign Application Priority Data
May 21, 2007 (DE) 10 2007 023 543.9

(51) Int. Cl. G06F 17/30

(52) U.S. Cl. 707/104.1; 707/E17.101

(57) ABSTRACT

An audio and/or video file and method for providing audio and/or video files, wherein each audio and/or video file is subdivided in at least three parts, a first part of the audio and/or video file being provided in a first quality, a second part being provided in a second quality, additional information is provided in a third part, and the second quality being less than the first quality.

The invention relates to a method for providing audio and/or video files and to a audio and/or video file, in particular provided over a communication channel.

Audio and/or video files are known in many different ways. Such files may be provided over communication channels like internet or on a number of different storage devices known in the art, like CDROM, DVD or solid state memory means. Provided for example over internet, the user may download a short part of such files to hear the music or see the film in parts before buying them. In the most cases this is unsatisfactory as the excerpts are very short and the user does gain an insufficient impression of the music or the film.

From the US 2003/0014310 A1 it is for example known to provide multimedia files over the internet. These files are provided for free in complete length and in a high quality but only in combination with advertisements. By providing files in this way, the user has not to buy the multimedia files to get the complete file.

It is therefore an object of the present invention to provide audio and/or video files completely, allowing the users to gain a sufficient impression of the respective files but without providing already a complete file in high quality, so that the user has to buy the files to obtain the complete file in high quality.

To achieve the above object of the invention, according to one aspect of the invention, there is provided a method for providing audio and/or video files, wherein each audio and/or video file is subdivided in at least three parts, a first part of the audio and/or video file being provided in a first quality, a second part being provided in a second quality, additional information is provided in a third part, and the second quality being less than the first quality.

According to another aspect of the invention, there is provided an audio and/or video file comprising at least three parts, a first part with a first quality, a second part with a second quality, and a third part containing additional information, and that the second quality is less than the first quality.

According to the method according to the invention, the user may listen to or see the complete file, partly in a high quality, partly in a reduced quality. At the same time, additional information may be shown comprising for example information about possible points or channels of sale. To achieve this, the file will be subdivided in at least three parts, a first part being provided in a first quality, a second part being provided in a second quality, additional Information being provided in a third part, and the second quality being less than the first quality. Preferably, the duration of the first part is shorter than the duration of the second part. The file may also contain more than three parts. In this case, the last part contains additional information and the other parts may be of different qualities. The audio and/or video files may be provided over a communication channel or storage means to a user terminal.

The additional information may be presented in a graphical or textual form. On opening the audio and/or video file, the additional information is displayed on the user terminal and presented to the user. The additional information contains information about possible points or channels of sale to inform the user where the can buy this file. Thus, the user may hear or see the complete file, partly in a reduced quality. On hearing or seeing this file, information, where to buy this file, is presented to him. The user may then visit the point or channels of sale, for example web sites, and then order for example a CD or DVD comprising this file, or download the complete file in full quality after payment of a fee.

The additional information may also contain information about the first and second part of the audio and/or video file, for example the title, interpreter or actors. Preferably, by opening the web sites statistical information about the visit of the web site is stored. This statistical information may contain information about the file. This statistics may be used to prepare charts.

The invention will now be described in detail in reference with the drawings, in which:

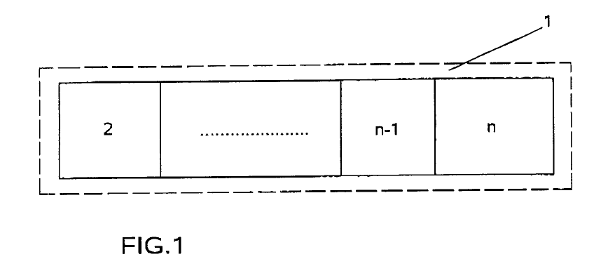

FIG. 1 is a general example for an audio and/or video file,

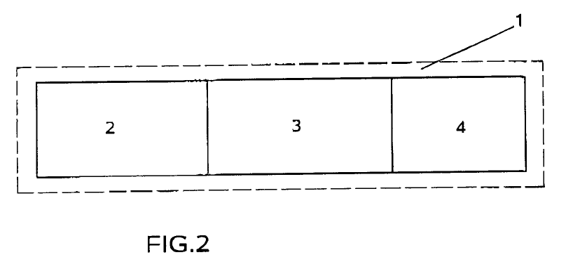

FIG. 2 is a special example for such a file,

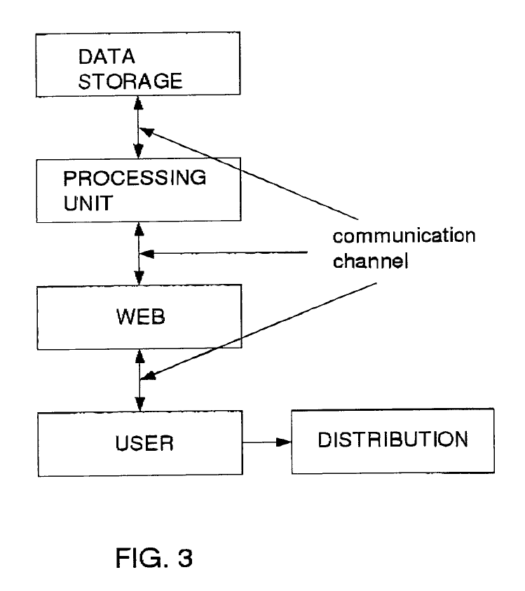

FIG. 3 is a block diagram illustrating the method.

FIG. 1 shows the general example for an audio and/or video file. Such a file may be of any format like MP3, WAV, AVI, MID, etc. The file 1 includes several parts 2 to n. The parts 2 to n−1 include audio and/or video information. These parts may be of different qualities. Preferably, the first part 2 is provided in a first quality, for example 256 kbit/s. The other parts 3 to n−1 are preferably provided in a quality being less than the first quality, for example 128 kbit/s or less. With these qualities it is possible for the user to hear or see the complete file, but only a part of this may be heard or seen in very high quality. The quality of the other parts is such low that the user may hear or see the music or video only with strong restrictions. The file 1 also comprises additional information provided in the last part n. This additional information may contain information about the music or video, information about possible points or channels of sale, information about web sites containing further information about the file or buying information, or something similar.

It is also possible that part 2 has a lower quality than the other parts. One or several parts of the parts 2 to n−1 should be of a high quality, the rest of the parts should be of a lower quality.

FIG. 2 shows a specific example for such a file. The file 1 contains three parts 2-4. Parts 2 and 3 contain the audio and/or video information, part 4 contains the additional information. The first part 2 is of a high quality, the second part 3 is of a lower quality than the first part 2. Part 2 has a duration of 30 seconds, part 3 has normally a longer duration. The quality and the duration of the parts 2 and 3 may also be reversed.

In FIG. 3, a flow diagram of the method providing an audio and/or video file according to the invention is shown. In this preferred embodiment, a data storage is provided comprising a number of audio and/or video files. These files are presented on a web site. Between the web site and the data storage, a processing unit is provided. This processing unit is responsible for adding additional information to the files and for subdividing the file in several parts with high and reduced quality, or for providing the files completely in a high quality. A user may access the web site over a communication channel, for example over internet. The user then may select one or several of the presented files. It is checked by the processing unit, whether the user has not yet bought the respective file, but is interested in hearing or seeing this file, or whether the user has already bought this file on the web site. In the second case, the access to the complete file is allowed over this processing unit. Otherwise, only the file containing additional information and being partly of reduced quality is transmitted via the communication channel. The additional information is presented to the user on his terminal giving information about distributors for the respective file. The user then may decide if to buy the file on the web site or at other distributors. It the user will buy the file on the web site, the web site gives this information to the processing unit. The processing unit then will allow the access to the complete file without any restrictions or additional information.

On visiting the web site, statistical information is collected. This statistical information may contain the number of visits of the web site, or the selected file. On base of the statistical information, statistics are built. These statistics are used to make a chart list. These statistics may also be used to build an overview of the popularity of different files.

1. A method for providing audio and/or video files, wherein each audio and/or video file is subdivided in at least three parts, a first part of the audio and/or video file being provided in a first quality, a second part being provided in a second quality, additional information is provided in a third part, and the second quality being less than the first quality.

2. The method of claim 1, wherein the duration of the first part is shorter than the duration of the second part.

3. The method of claim 2, wherein the duration of the first part is 30 seconds.

4. The method of claim 1, wherein the additional information is presented in a graphical or textual form.

5. The method of claim 1, wherein the audio and/or video files are provided over a communication channel.

6. The method of claim 1, wherein the audio and/or video files are provided on storage means.

7. The method of claim 1, wherein the audio and/or video files are provided to a user terminal.

8. The method of claim 5, wherein, on opening the audio and/or video files, the additional information is displayed on the user terminal.

9. The method claim 8, wherein the additional information contains information about possible points or channels of sale.

10. The method of claim 8, wherein the additional information contains information about the first and second part of the audio and/or video file.

11. The method of claim 8, wherein the additional information contains information about web sites, which may be accessed directly.

12. The method of claim 11, wherein on opening the web sites statistical information about the visit of the web site is stored.

13. The method of claim 12, wherein the statistics are used to prepare charts.

14. An audio and/or video file, said file comprising at least three parts, a first part with a first quality, a second part with a second quality, and a third part containing additional information, the second quality being less than the first quality.

15. The audio and/or video file of claim 14, wherein the duration of the first part is shorter than the duration of the second part.

16. The audio and/or video file of claim 15, wherein the duration of the first part is 30 seconds.

17. The audio and/or video file of claim 14, wherein the additional information has a graphical or textual format.

18. The audio and/or video file of claim 14, wherein the audio and/or video file is provided over a communication channel.

19. The audio and/or video file of claim 14, wherein the audio and/or video file is provided on storage means.

20. The audio and/or video file of claim 18, wherein the audio and/or video file is provided to a user terminal.

21. The audio and/or video file of claim 20, wherein the additional information is displayed on the user terminal by opening the audio and/or video file.

22. The audio and/or video file of claims 14, wherein the additional information contains information about possible points or channels of sale.

23. The audio and/or video file of claim 14, wherein the additional information contains information about the first and second part of the audio and/or video file.

24. The audio and/or video file of claim 14, wherein the additional information contains information about web sites, which may be accessed directly.

25. The audio and/or video file of claim 24, wherein a statistic is provided, in which, by opening the web sites, statistical information is stored about the visit of the web site.

26. The audio and/or video file of claim 25, wherein charts built on the base of the statistics are provided.
